(19) United States
(12) Patent Application Publication
(10) Pub. No.: US 2017/0267898 A1
(43) Pub. Date: Sep. 21, 2017

(54) ATTACHING AN ACCESSORY TO A COMPUTING DEVICE

(71) Applicant: Microsoft Technology Licensing, LLC, Redmond, WA (US)

(72) Inventors: Aseem Singla, Redmond, WA (US); Gabriel Pirie, Seattle, WA (US)

(73) Assignee: Microsoft Technology Licensing, LLC, Redmond, WA (US)

(21) Appl. No.: 15/076,469

(22) Filed: Mar. 21, 2016

(51) Int. Cl. C09J 7/02; G06F 3/0354; G06F 3/039; G06F 3/023

(52) U.S. Cl. CPC C09J 7/0285; G06F 3/023; G06F 3/03545; G06F 3/039; C09J 2203/326; C09J 2433/00; C09J 2471/006

(57) ABSTRACT

Examples are disclosed that relate to the use of a microstructured adhesive tape for attaching an accessory device onto a computing device. One example provides a system, comprising a computing device, and an accessory device mountable to the computing device via a microstructured adhesive tape on one of the computing device and the accessory device, the microstructured adhesive tape configured to adhere to a mating surface on another of the computing device and the accessory device.

### BACKGROUND

Computing devices, such as laptop computers, tablet computers, and mobile computing devices, may be configured to be used with various accessory devices, including but not limited to styluses and keyboards.

### SUMMARY

Examples are disclosed that relate to the use of a microstructured adhesive tape for attaching an accessory device onto a computing device. One example provides a system comprising a computing device and an accessory device mountable to the computing device via a microstructured adhesive tape on one of the computing device and the accessory device, the microstructured adhesive tape configured to adhere to a mating surface on another of the computing device and the accessory device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A, 1B, and 1C show example computing systems each comprising a computing device and an accessory device.

FIG. 2 shows an example accessory device comprising a microstructured adhesive tape.

FIG. 3 shows a profilometer image of an example microstructured adhesive material.

FIG. 4 shows a graph illustrating peak pull forces exhibited versus a number of pull cycles for an example set of microstructured adhesive tape samples before and after washing.

FIG. 5 shows a graph illustrating peak shear forces exhibited versus a number of pull cycles for the example set of microstructured adhesive tape samples of FIG. 4 before and after washing.

FIG. 6 shows an image of an example microstructured adhesive tape sample after exposure to dust and before washing.

FIG. 7 shows an image of the example microstructured adhesive tape sample of FIG. 6 after washing.

FIG. 8 shows a graph illustrating peak pull forces exhibited over time by an example set of microstructured adhesive tape samples exposed to ultraviolet degradation.

FIG. 9 shows a graph illustrating peak shear forces exhibited over time by the example set of microstructured adhesive tape samples of FIG. 8.

FIG. 10 shows a graph illustrating peak pull forces exhibited over time by an example set of microstructured adhesive tape samples exposed to temperature cycling conditions.

FIG. 11 shows a graph illustrating peak shear forces exhibited over time by the example set of microstructured adhesive tape samples of FIG. 10 exposed to temperature cycling conditions.

FIG. 12 shows a graph illustrating peak pull forces exhibited over time by an example set of microstructured adhesive tape samples exposed to high temperature and humidity conditions.

FIG. 13 shows a graph illustrating peak shear forces exhibited over time by the example set of microstructured adhesive tape samples of FIG. 12 exposed to high temperature and humidity conditions.

FIG. 14 shows a graph illustrating pull forces exhibited by an example microstructured adhesive tape sample versus displacement of the microstructured adhesive tape sample over ten cycles.

FIG. 15 shows a graph illustrating pull forces exhibited by another example microstructured adhesive tape sample versus displacement of the microstructured adhesive tape sample over ten cycles.

FIG. 16 shows a graph illustrating a maximum pull force exhibited by the example microstructured adhesive tape sample of FIG. 14 versus cycle number.

FIG. 17 shows a graph illustrating a maximum pull force exhibited by the example microstructured adhesive tape sample of FIG. 15 versus cycle number.

FIG. 18 shows a graph illustrating shear force exhibited by an example microstructured adhesive tape sample versus displacement of the microstructured adhesive tape sample.

FIG. 19 shows a graph illustrating shear force exhibited by another example microstructured adhesive tape sample versus displacement of the microstructured adhesive tape sample.

### DETAILED DESCRIPTION

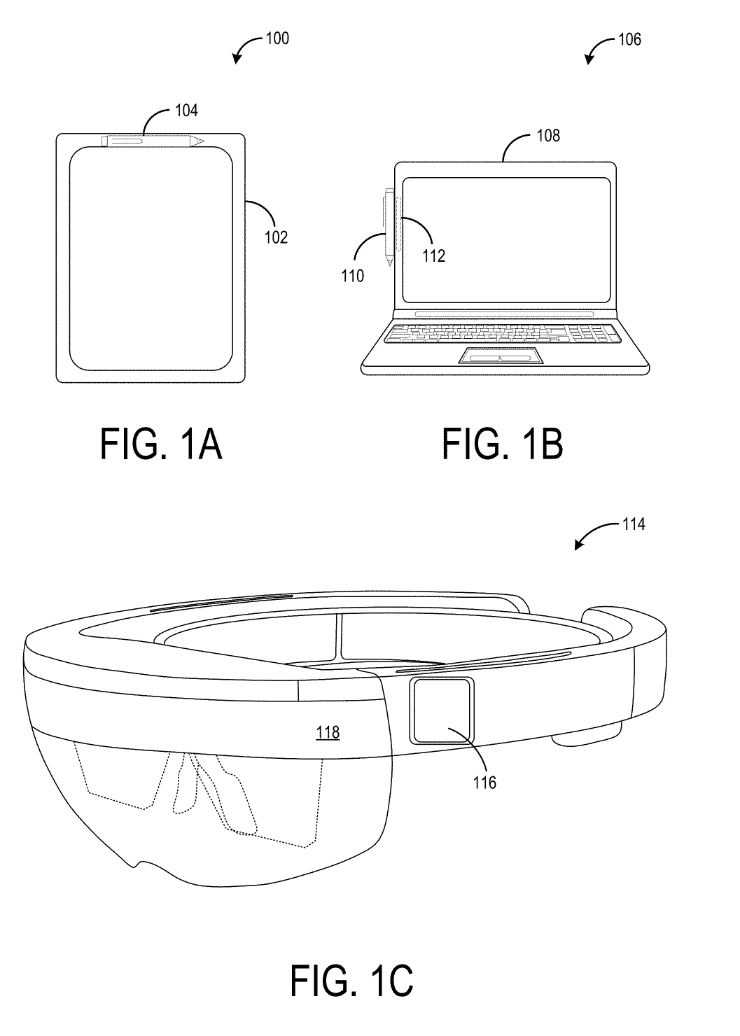

As mentioned above, a computing device may be configured to be used with one or more accessory devices. For convenience, some accessory devices, such as a stylus or a keyboard, may be configured to be removably attached to the computing device. For example, FIGS. 1A and 1B respectively show a tablet computing device 102 having a stylus 104 mounted to a top portion of a front surface and a laptop computing device 108 having a stylus 110 attached to a side.

Accessories may be attached to computing devices in various manners. For example, a computing device may include mechanical storage features, such as a slot, hook, clamp, or other connector, configured to receive and retain an accessory such as a stylus. However, the addition of such a storage feature may impact the design and aesthetic appearance of the computing device. Other computing devices may include the use of magnets to retain an accessory device. However, such magnetic attachments may not resist removal by lateral forces, such as those encountered when placing a tablet into a backpack or briefcase. As such, an accessory may be knocked loose by such actions.

Accordingly, examples are disclosed herein that relate to the use of a microstructured adhesive tape for attaching an accessory device onto a computing device. The disclosed microstructured adhesive tape examples may adhere to a surface without the use of conventional adhesive tape coatings, while still providing attachment forces that are sufficiently strong to resist lateral forces. The disclosed microstructured adhesive tape examples further may be cleaned to restore adhesive properties if adhesive performance is impacted by contaminants (e.g. dust, lotions, etc.). In some examples, such microstructured adhesive tapes may be used together with magnets to further help align and keep the accessory device in place on the computing device.

Continuing with FIGS. 1A and 1B, a microstructured adhesive tape may be located on the computing devices 102, 108, or on the styluses 104, 110. Where the microstructured adhesive tape is located on a stylus, a computing device may include a complementary mating surface formed from a mating surface material configured for secure adhesion of the microstructured adhesive tape. Likewise, where a microstructured adhesive tape is located on the computing device, a stylus may include a complementary mating surface. A complementary mating surface may be formed from any suitable mating surface material, such as a material having a surface finish of 1 micron or less, examples of which include but are not limited to a smooth glass or plastic surface. FIG. 1B also schematically shows an optional magnet 112 within the laptop computing device 106. The magnet 112 may provide additional attachment force, and may help to align the stylus 110 in a desired orientation along a side of the laptop computing device 106. In some examples, a body of the stylus 110 may be at least partially constructed from a magnetic material (e.g. steel or other material containing a ferromagnetic element or compound), that is attracted by the magnet 112. In yet other examples, one or more magnets may be incorporated into an interior of the stylus 110, and the laptop computing device 106 may include a magnetic material.

FIG. 1C shows another example computing system 114 including an accessory device coupled to a computing device via a microstructured adhesive tape. In this example, the computing device takes the form of a wireless remote input and/or output device 116 removably mounted to a head-mounted display device 118. The remote input and/or output device 116 may be removed from the head-mounted display device 118 for use in making gesture inputs, touch inputs, and/or other suitable inputs. The remote input and/or output device 116 also may be used to provide outputs from the head-mounted display device, such as audio outputs, haptic outputs, visual outputs, and/or other suitable outputs to provide feedback from the head-mounted-display device. As in the examples of FIGS. 1A and 1B, the microstructured adhesive tape may be located on either the remote input/output device 116 or the head-mounted display device 118, while the other device may include a complementary mating surface to which the microstructured adhesive tape can adhere. The microstructured adhesive tape may thus allow the remote input and/or output device 116 to be secured to the head-mounted display device 118 while worn on a user's head and removed when it is desired, e.g. to make user inputs with or to receive feedback from the remote input/output device 116. In other examples, the remote input and/or output device 116 may be configured to attach to any suitable location on the head-mounted display device 118 other than the location shown in FIG. 1C. Further, as described above, in some examples the microstructured adhesive tape may be used in combination with one or more magnets to for additional attachment force. For example, one or more magnets may be located on the head-mounted display device 118 and the remote input/output device 116 may be made partially from a magnetic material that is attracted by the one or more magnets, or vice versa. In other examples, the microstructed adhesive tape may be used in combination with yet other attachment mechanisms, such as a spring clamp. The examples of FIGS. 1A-IC are illustrative and not limiting, as a microstructured adhesive tape may be used to attach any suitable accessory device to any corresponding computing device.

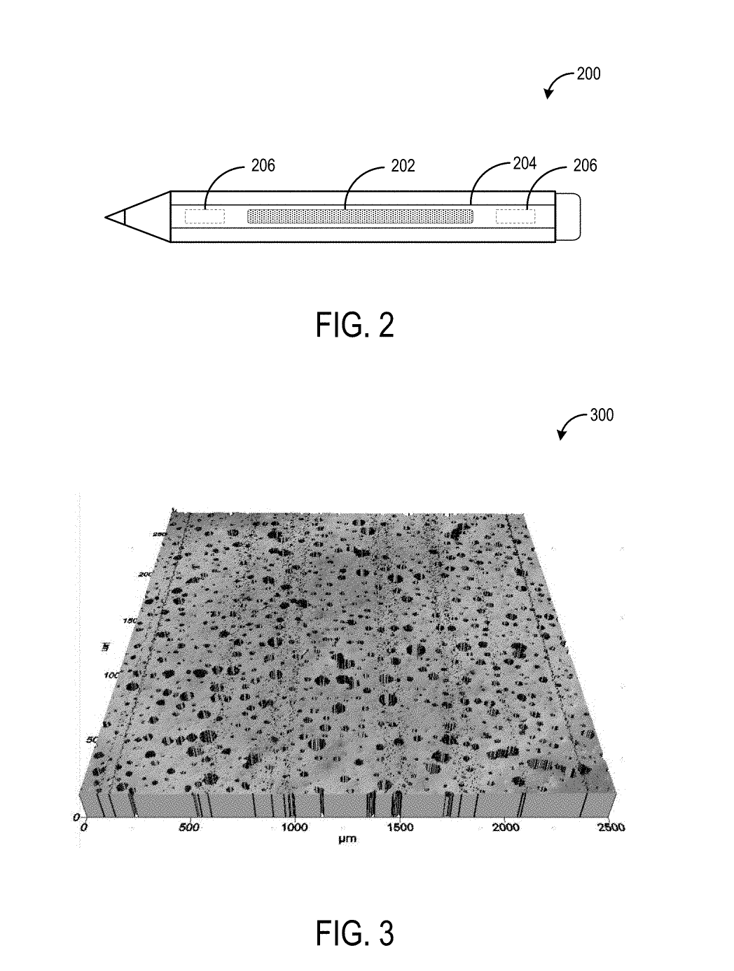

FIG. 2 shows an example stylus 200 in more detail. The stylus 200 comprises a microstructured adhesive tape 202 on a support surface 204 of the stylus 200. In the depicted example, the support surface 204 comprises a planar surface formed in a side of the stylus 200 to which the microstructured adhesive tape 202 is attached, but may have any other suitable configuration. As mentioned above, in other examples, the stylus 200 may include a complementary mating surface (e.g. a surface made of glass or other suitably smooth material) to receive attachment of a microstructured tape located on the computing device. In further examples, an accessory device and a computing device may have any other suitably shaped support surfaces and complementary mating surfaces, such as complementary curved surfaces. In any of these examples, the complementary mating surface on the computing device may be configured to have a visually distinct appearance from the surrounding surfaces on the computing device, while in other examples the complementary mating surface may be configured to have a similar appearance so as not to stand out. The stylus 200 may further include optional magnet(s) 206 disposed within or on the body for additional attachment force. In other examples, the stylus 200 may include a magnetic material that is attracted by one or more magnets located on the computing device, as described above.

A microstructured adhesive tape is configured to adhere to other surfaces via microscopic structures that are part of the tape, rather than via a layer of an adhesive applied to a tape. For example, a microstructured adhesive tape may include micro-suction cups formed in a component of the tape. The term “micro-suction cups” as used herein may refer to a configuration that allows the tape to adhere to surfaces via suction-like properties when the tape is applied to a suitable surface. As another example, a microstructured tape may include a biomimetic material comprising a plurality of synthetic setae configured to adhere to a surface via dispersive adhesive forces, e.g. van der Waals forces.

FIG. 3 shows a profilometer image of an example microstructured adhesive material 300 that may be utilized as the microstructured adhesive tape of FIG. 2. In this example, the microstructured adhesive material 300 includes microscopic pits/openings in a surface of the material, which may create partial vacuums between the tape and a target surface. The microscopic features may have any suitable sizes and configurations other than those shown. An adhesive layer may be applied to a surface of the microstructured adhesive tape to more permanently adhere the microstructured adhesive tape to an object (e.g. an accessory device or computing device), while allowing the microstructured adhesive material to face outwardly to bond to other surfaces.

One non-limiting example of a suitable microstructured adhesive tape is sold under the name REGABOND-S by EXEL TRADING CO., LTD. This tape includes an acrylic foam material in which the micro-suction cups are formed, a polyethylene terephthalate (PET) film supporting the acrylic foam, and an acrylic adhesive disposed on the another side of the PET film. Table 1 shows technical data of tensile properties for a sample of REGABOND-S. The elongation refers to the increase in length of the material after exposure to a maximum amount of stress the material may withstand before fracture, as a percentage of the original material length. The tensile stress represents a maximum amount of stress the material may withstand before fracture.

TABLE 1
Technical data for standard REGABOND-S

| Thickness | Elongation | Tensile Strength |
|---|---|---|
| 0.8 mm | 400% | 12.74 N/cm |

Table 2 shows stick strength data for standard samples of REGABOND-S on various materials. Stick strength, also referred to herein as pull force, refers to the strength of force able to be exerted on REGABOND-S while still remaining attached to a tested surface, and in particular, the force needed to detach the sample of REGABOND-S when pulling the tape in a direction normal to the test surface. The presented data is provided by the manufacturer referenced above, and was gathered using laminating a standard REGABOND-S sample on a copper foil, and pressing the sample on each test material surface by a 5 kg/wgt roller. The data was measured while exerting 300 mm/min tensile speed on the sample after 24 hours in standard conditions (i.e. at 23±2° C. and 60±5% relative humidity). The material abbreviations refer to the following: GL for glass, SUS for stainless steel, AL for aluminum, PP for polypropylene, PET for polyethylene terephthalate, and ACL for acrylic.

TABLE 2
Stick strength of sample tape on materials

Material

| | GL | SUS | AL | PP | PET | ACL |
|---|---|---|---|---|---|---|
| N/50 mm | 3.23 | 3.04 | 3.23 | 3.04 | 3.53 | 3.23 |

Table 3 shows shear strength data for a sample of REGABOND-S as measured across varying temperature conditions, as provided by the manufacturer. Shear strength, also referred to herein as shear force with regard to experimental results described below, refers to the force needed to detach a REGABOND-S sample from a test surface when exerting force on the tape in a direction parallel to the plane of the test surface. The REGABOND-S was pressed by a 5 kg/wgt roller onto a test material, and data was measured by exerting 300 mm/min tensile speed after 24 hours for each temperature condition.

TABLE 3
Shear strength of standard REGABOND-S

Temperature ° C.

| | −10 | 0 | 10 | 23 | 40 | 55 |
|---|---|---|---|---|---|---|
| N/cm² | 21.17 | 18.33 | 17.15 | 16.46 | 13.33 | 11.96 |

Table 4 shows technical data for the micro-suction cup adhesive side of REGABOND-S as provided by the manufacturer. Exhibited force strengths are listed for various materials. The stick strength was again measured by exerting 300 mm/min tensile speed on the sample in standard conditions of 23±2° C. and 60±5%. The shear strength was measured for a 25 mm×25 mm surface area and after loading 1 kg for 2 hours at 40° C. The heat resistance shear strength was measured for a 25 mm×25 mm surface area and after loading 500 g for 2 hours at 90° C.

TABLE 4
Technical data for adhesive side of REGABOND-S

| | | | | |
|---|---|---|---|---|
| Stick Strength | Initial | SUS | N (g)/ | 13.13 (1340) |
| | | AL | 25 mm | 11.25 (1148) |
| | | PP | | 12.13 (1238) |
| | After | SUS | | 15.38 (1569) |
| | 24 H | AL | | 14.13 (1442) |
| | | PP | | 12.63 (1289) |

| | | | |
|---|---|---|---|
| Shear Strength | SUS | mm | 0.4 |
| | AL | | 0.4 |
| | PP | | 0.4 |
| Heat Resistant | SUS | | 0.5 |
| Shear Strength | AL | | 0.8 |
| | PP | | 1.0 |

Table 5 shows durability data of REGABOND-S, as provided by the manufacturer.

TABLE 5
Durability data of REGABOND-S

| Test | Term | | Result |
|---|---|---|---|
| Heat Cycle | [symbol] −20° C. × 2 H→Normal Condition × 0.5 H | | Non-discoloration |
| Resistance | [symbol] →50° C. 98% RH × 3 H→Normal Condition × 0.5 H | | Non -swelling |
| | [symbol] →−20° C. × 2 H→Normal Condition × 0.5 H | | Non- peeling |
| | [symbol] →80° C. × 10 H→Normal Condition × 0.5 H | | Non-deterioration |
| | 5 Cycle | | |
| Accelerated | Sunshine Weather meter 400 H | | Non-discoloration |
| Weathering | Dew-Cycle weather meter 240 H | | Non- deterioration |
| Test | | | |
| Adsorption | Initial | Stainless Steel | 3.04N/50 mm |
| Force JIS- | | Glass | 3.14N/50 mm |
| Z0237 | 24 H | Stainless Steel | 6.08N/50 mm |
| | | Glass | 6.37N/50 mm |
| Repetitive | 15 Sec | Stainless Steel | 2.74N/50 mm |
| Adsorption | 240 times | Glass | 3.04N/50 mm |
| Force | | | |

[symbol]

indicates data missing or illegible when filed

In the experiments described below, pull and shear forces, as well as cosmetic changes, were recorded for test samples of REGABOND-S sheets mounted to sample aluminum blocks and tested by adhering to a test glass surface. In the performed experiments, pull force was measured by a load cell while the aluminum block was adhered to the test glass surface and mechanically pulled via an attachment of a clamp in a direction normal to the test glass surface. Shear force was similarly measured, where shear force was exerted on sample aluminum blocks in a direction parallel to the test glass surface. The REGABOND-S sample sheets used were of a thickness of 0.3 millimeters. Table 6 shows a summary of the tests performed on the REGABOND-S samples.

TABLE 6
Summary of tests performed on samples of REGABOND-S

| Sample | | | |
|---|---|---|---|
| Qty | Test Name/Condition | Measurements | Check Points |
| 2 | Durability | Pull and Shear | 0, 500, 800, |
| | | Force | 1000, 2000 |
| 4 | Dust Settling 6 g/m³ | Pull Shear Force | 0, 24 |
| | settle for 24 hrs | and VI (Visual | |
| | | inspection) | |
| 2 | Ultraviolet Radiation at | Pull Shear Force | 0, 48, 96, 144, |
| | 420 nm | and VI | 200 |
| 12 | *Chemical, Ambient and | VI | 0, 12, +24 |
| | at 60° C., 65% Relative | | |
| | Humidity | | |
| 4 | Temperature Cycling at | Pull and Shear | 0, 48, 96, 144 |
| | 20°-60° C. | Force | |
| 4 | Temperature and | Pull and Shear | 0, 48, 96, 144 |
| | Humidity at 55° C. and | Force | |
| | 85% | | |

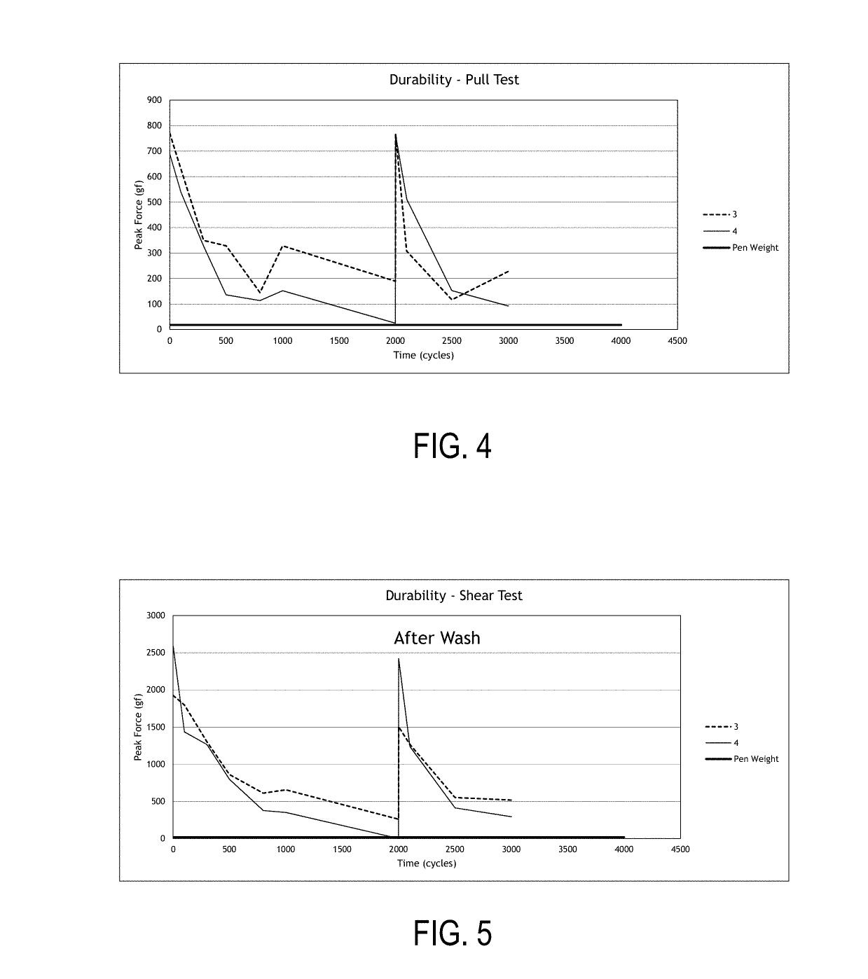

FIG. 4 and FIG. 5 respectively show graphs of peak pull forces achieved and peak shear forces measured for an example set of REGABOND-S samples over a number of cycles, a cycle referring to the attachment and detachment of the sample to the test surface once, before and after washing the REGABOND-S samples for the first time. The stylus weight is also shown, referring to the weight of each aluminum block having a REGABOND-S sheet used in the experiments. The REGABOND-S samples were washed with soap and water after 2000 cycles of attachment and detachment. As shown in FIGS. 4 and 5, the peak pull forces and peak shear forces decreased with usage, and were renewed after washing. Thus, such a microstructured adhesive tape may be repeatedly used to adhere an accessory device to a computing device, and may be cleaned after repeated uses to restore its adhesive properties.

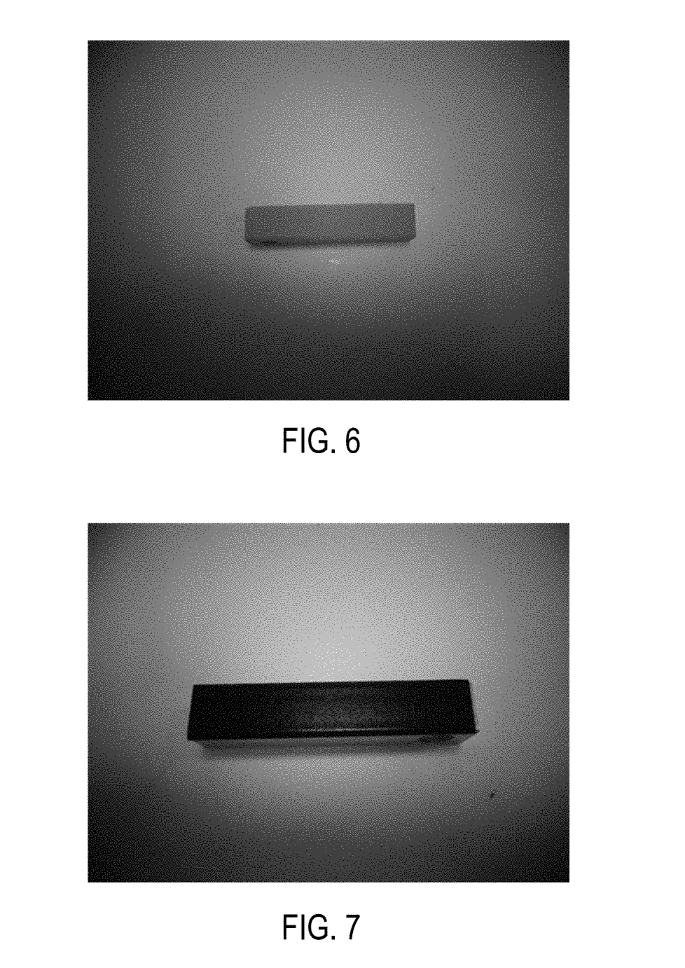

Table 7 summarizes data regarding REGABOND-S samples tested in dust settling experiments. Specifically. Table 7 shows the grab forces (pull and shear forces) measured for REGABOND-S samples initially at “Time 0”, after dust was allowed to settle on the samples at “Time 24”, after brushing off the dust from the samples, and after cleaning the samples with soap and water. FIG. 6 and FIG. 7 show images of an example REGABOND-S sample before and after cleaning off settled dust, respectively. The data of Table 7 show that after dust settling, the grab forces were degraded by 100% to 0 N, but after washing off the dust, the degradation of grab forces ranged from approximately 12% to 45%. These results indicate that settling of dust on the surface of the microstructured adhesive tape may degrade the grab forces, but cleaning with soap and water at least partially restores the initial grab force levels.

TABLE 7
Grab forces of REGABOND-S samples before and after dust settling,
and after cleaning

| | | | | | | After Cleaning | |
|---|---|---|---|---|---|---|---|
| | | | Time 0 | | After | w/ Soap | |
| DUT | Start | Data | (Grab force | Time 24 | Brush | and | Delta |
| Number | Date: | Type: | in Newtons) | Settling | Off | Water | Percentage |
| 7 | Oct. 6, 2014 | Pull | 1103.455 | 0 | 0 | 601.2944 | 45.5% |
| 7 | Oct. 6, 2014 | Shear | 2589.753 | 0 | 0 | 1936.138 | 25.2% |
| 8 | Oct. 6, 2014 | Pull | 1171.803 | 0 | 0 | 1032.002 | 11.9% |
| 8 | Oct. 6, 2014 | Shear | 2956.765 | 0 | 0 | 2387.191 | 19.3% |
| 9 | Oct. 6, 2014 | Pull | 1157.209 | 0 | 0 | 995.0905 | 14.0% |
| 9 | Oct. 6, 2014 | Shear | 3028.468 | 0 | 0 | 2101.191 | 30.6% |
| 10 | Oct. 6, 2014 | Pull | 1333.246 | 0 | 0 | 974.3231 | 26.9% |
| 10 | Oct. 6, 2014 | Shear | 3252.69 | 0 | 0 | 2447.36 | 24.8% |

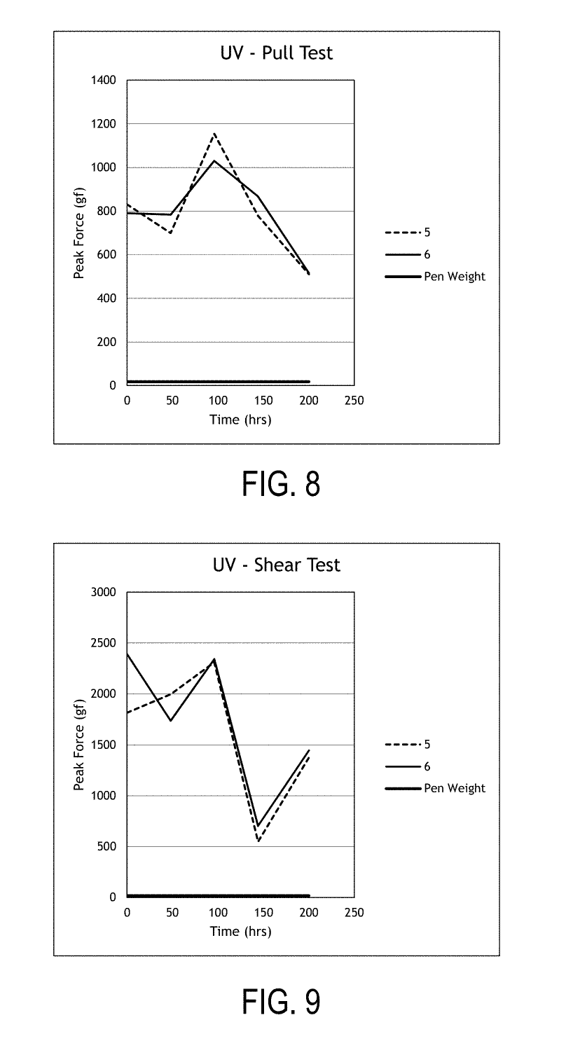

FIG. 8 and FIG. 9 respectively show graphs of peak pull forces and peak shear forces exhibited over time by an example set of REGABOND-S samples attached to a test glass surface exposed to ultraviolet radiation of 420 nanometers. The pull and shear forces exhibited by the REGABOND-S samples decreased with relatively longer ultraviolet radiation exposure, but the forces were sufficient to retain attachment of the aluminum blocks to the test glass surface.

Surface contaminant tests were also performed on REGABOND-S samples to mimic potential exposure to surface contaminants that may occur during actual use of a microstructured adhesive tape. First, a hand lotion (OLAY lotion, available from Procter & Gamble Co. of Cincinnati, Ohio, U.S.A.) was applied on a REGABOND-S sample, and the tape sample was subsequently washed. In another example experiment, petroleum jelly was similarly applied and washed. It was found that the cosmetic appearance of REGABOND-S soiled by the tested surface contaminants may be restored after washing. Additional tests were further performed testing the same surface contaminants in conditions of 60° C. and 65% relative humidity. Again, it was found that the cosmetic appearance of REGABOND-S soiled by the tested surface contaminants may be restored after washing.

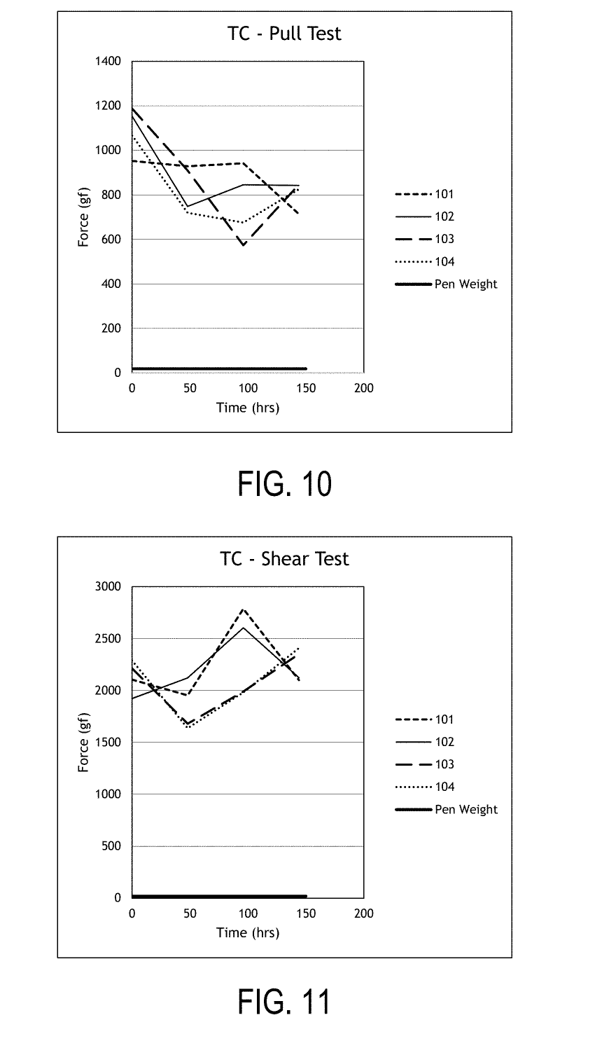

FIG. 10 and FIG. 11 respectively show graphs of peak pull forces and shear forces exhibited over time by an example set of REGABOND-S samples when exposed to temperature cycling conditions of 20° C. to 60° C. Although the pull and shear forces varied over temperature cycling conditions as shown, the adhesion strength may remain suitable for use in attaching an accessory, such as a stylus, to a computing device.

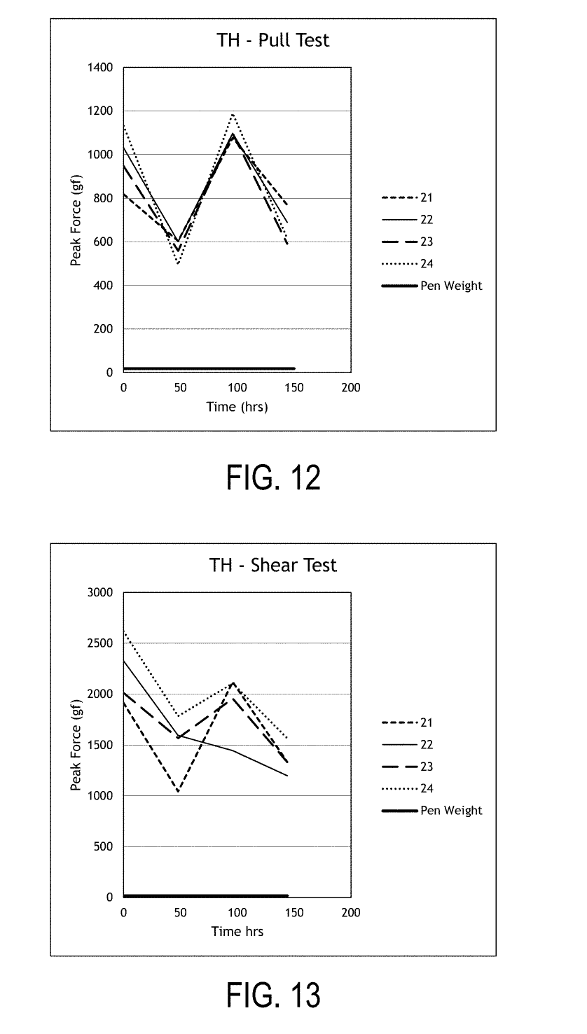

FIG. 12 and FIG. 13 respectively show graphs of peak pull forces and shear forces exhibited over time on a stylus for another example set of REGABOND-S samples when exposed to a temperature of 55° C. and a relative humidity of 85%. These figures also show that the pull and shear forces vary over time in such conditions, but may provide suitable adhesion strength after exposure to such conditions.

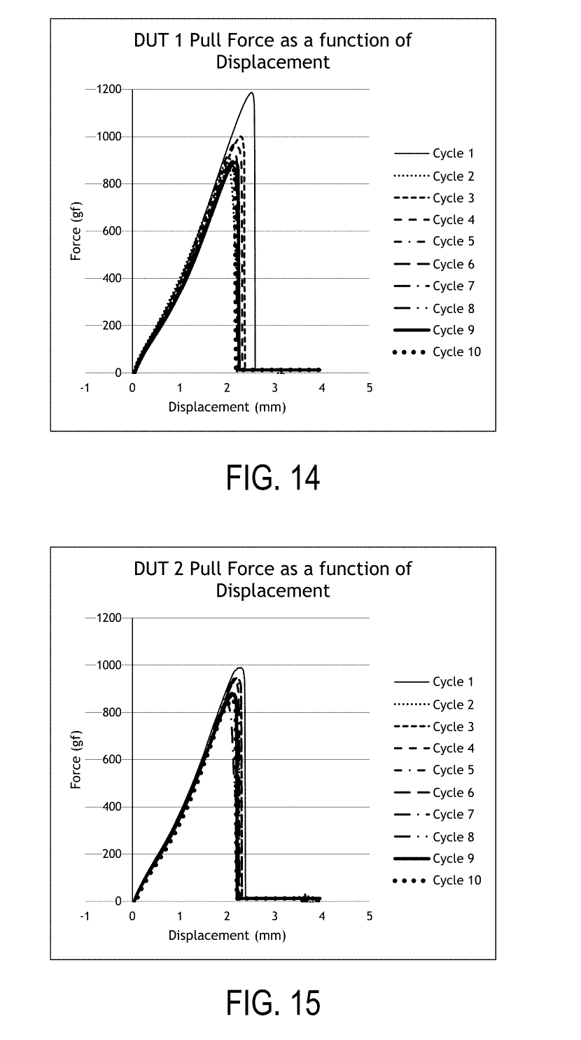

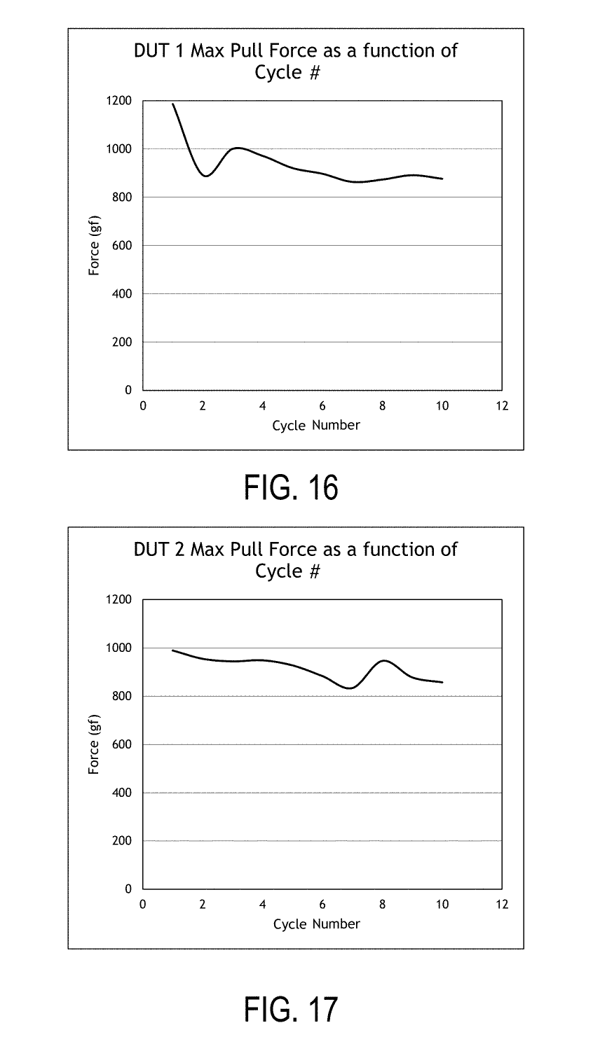

FIG. 14 and FIG. 15 show graphs of pull forces exhibited by two respective REGABOND-S samples as a function of displacement in millimeters over ten sampled cycles. The graphs show that the REGABOND-S samples stretch with increase in exerted pull force until approximately 2-3 mm of displacement, at which point the sample detaches from the test glass surface. The REGABOND-S samples exhibited maximum pull force strengths of approximately over 800 gram forces (gf) to 1200 gf over the ten cycles in this experiment. FIGS. 16 and 17 show graphs of the maximum pull forces exhibited by the two respective REGABOND-S samples versus number of runs.

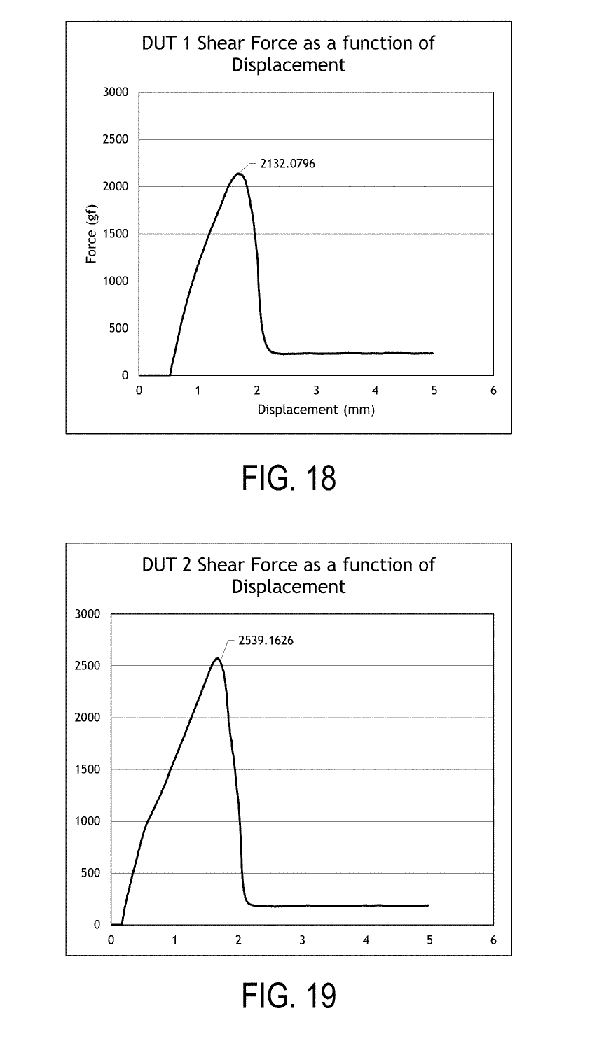

FIG. 18 and FIG. 19 show graphs of shear forces exhibited by the two respective REGABOND-S samples as a function of displacement of each sample for one cycle. These graphs show that the REGABOND-S samples exhibited maximum shear force strengths of approximately 2,132 gf and 2,539 gf respectively.

The results of the above described experiments indicate that even after repeated uses and with exposure to debris, dust, oils, etc., a portion to all of the initially exhibited adhesive strength of REGABOND-S may be restored by washing the micro-suction cup surface, e.g. with mild soap and water. Further, environmental conditions such as ultraviolet radiation, high temperature, humidity, and temperature cycling conditions may not affect the adhesive strength of REGABOND-S sufficiently to make it unsuitable for use in attaching an accessory to a computing device. Thus, such a microstructured adhesive tape may provide for a stronger and reusable adhesive mechanism to attach an accessory device to a computing device than that provided by magnetic attachments alone.

In other examples, other types of micro-suction cup tape may be utilized. Further, other microstructured adhesive tapes than micro-suction tapes also may be used. For example, as mentioned above, a microstructured tape may include a plurality of synthetic setae configured to adhere to a surface via van der Waals forces. It will be understood that any other suitable types of microstructured adhesive tapes may be utilized.

Another example provides a system comprising a computing device and an accessory device mountable to the computing device via a microstructured adhesive tape on one of the computing device and the accessory device, the microstructured adhesive tape configured to adhere to a mating surface on another of the computing device and the accessory device. The mating surface may be additionally or alternatively located on the computing device, and the microstructured adhesive tape may be additionally or alternatively located on the accessory device. The mating surface may be additionally or alternatively formed from a mating surface material having a surface finish of less than or equal to one micron. The mating surface may be additionally or alternatively located on the accessory device, and the microstructured adhesive tape may be additionally or alternatively located on the computing device. The microstructured adhesive tape may additionally or alternatively include micro-suction cups. The microstructured adhesive tape may additionally or alternatively include synthetic setae. The system may additionally or alternatively include a magnet on one of the computing device and the accessory device and a magnetic material on another of the computing device and the accessory device. The computing device may additionally or alternatively include one or more of a laptop computing device, a tablet computing device, and a head-mounted display device. The accessory device may additionally or alternatively include one or more of a keyboard and a stylus.

Another example provides an accessory device comprising a support surface located on the accessory device, the support surface comprising a shape configured to interface with a complementary mating surface on a computing device, and a microstructured adhesive tape disposed on the support surface, the microstructured adhesive tape being configured and to attach to the complementary mating surface on the computing device. The microstructured adhesive tape may additionally or alternatively include micro-suction cups. The microstructured adhesive tape may additionally or alternatively include synthetic setae. The accessory device may additionally or alternatively include a magnetic material. The accessory device may additionally or alternatively include one or more of a keyboard and a stylus. The computing device may additionally or alternatively include one or more of a laptop computing device, a tablet computing device, and a head-mounted display device.

Another example provides a system, comprising a computing device, an accessory device mountable to the computing device via a micro-structured adhesive tape on one of the computing device and the accessory device, the micro-structured adhesive tape configured to adhere to an mating surface on another of the computing device and the accessory device, and one or more magnets located on one or more of the computing device and the accessory device to further secure the accessory device to the computing device. The mating surface may be additionally or alternatively located on the computing device, and the micro-structured adhesive tape may be additionally or alternatively located on the accessory device. The mating surface may be additionally or alternatively located on the accessory device, and the micro-structured adhesive tape may be additionally or alternatively located on the computing device. The computing device may additionally or alternatively include one or more of a laptop computing device, a tablet computing device, and a head-mounted display device. The accessory device may additionally or alternatively include one or more of a keyboard and a stylus.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A system, comprising:
a computing device; and
an accessory device mountable to the computing device via a microstructured adhesive tape on one of the computing device and the accessory device, the microstructured adhesive tape configured to adhere to a mating surface on another of the computing device and the accessory device.

2. The system of claim 1, wherein the mating surface is located on the computing device, and wherein the microstructured adhesive tape is located on the accessory device.

3. The system of claim 1, wherein the mating surface is formed from a mating surface material having a surface finish of less than or equal to one micron.

4. The system of claim 1, wherein the mating surface is located on the accessory device, and wherein the microstructured adhesive tape is located on the computing device.

5. The system of claim 1, wherein the microstructured adhesive tape comprises micro-suction cups.

6. The system of claim 1, wherein the microstructured adhesive tape comprises synthetic setae.

7. The system of claim 1, further comprising a magnet on one of the computing device and the accessory device and a magnetic material on another of the computing device and the accessory device.

8. The system of claim 1, wherein the computing device comprises one or more of a laptop computing device, a tablet computing device, and a head-mounted display device.

9. The system of claim 1, wherein the accessory device comprises one or more of a keyboard and a stylus.

10. An accessory device, comprising:
a support surface located on the accessory device, the support surface comprising a shape configured to interface with a complementary mating surface on a computing device; and
a microstructured adhesive tape disposed on the support surface, the microstructured adhesive tape being configured and to attach to the complementary mating surface on the computing device.

11. The accessory device of claim 10, wherein the microstructured adhesive tape comprises micro-suction cups.

12. The accessory device of claim 10, wherein the microstructured adhesive tape comprises synthetic setae.

13. The accessory device of claim 10, further comprising a magnetic material.

14. The accessory device of claim 10, wherein the accessory device comprises one or more of a keyboard and a stylus.

15. The accessory device of claim 10, wherein the computing device comprises one or more of a laptop computing device, a tablet computing device, and a head-mounted display device.

16. A system, comprising:
a computing device;
an accessory device mountable to the computing device via a micro-structured adhesive tape on one of the computing device and the accessory device, the micro-structured adhesive tape configured to adhere to an mating surface on another of the computing device and the accessory device; and
one or more magnets located on one or more of the computing device and the accessory device to further secure the accessory device to the computing device.

17. The system of claim 16, wherein the mating surface is located on the computing device, and wherein the micro-structured adhesive tape is located on the accessory device.

18. The system of claim 16, wherein the mating surface is located on the accessory device, and wherein the micro-structured adhesive tape is located on the computing device.

19. The system of claim 16, wherein the computing device comprises one or more of a laptop computing device, a tablet computing device, and a head-mounted display device.

20. The system of claim 16, wherein the accessory device comprises one or more of a keyboard and a stylus.
